(19) United States
(12) Patent Application Publication
(10) Pub. No.: US 2019/0311081 A1
(43) Pub. Date: Oct. 10, 2019

(54) Method for Designing a Forming Element for a Forming Tool and a Forming Element Produced by Way of Such a Method

(71) Applicants: Bayerische Motoren Werke Aktiengesellschaft, Muenchen (DE); Technische Universitaet Muenchen, Muenchen (DE)

(72) Inventors: Ingo HEINLE, Muenchen (DE); Sebastian KREISSL, Muenchen (DE); Alexander SCHMIDT, Olching (DE); Marco RAUPACH, Schoeps (DE)

(21) Appl. No.: 16/379,189

(22) Filed: Apr. 9, 2019

(30) Foreign Application Priority Data
Apr. 10, 2018 (DE) 10 2018 108 391.2

(51) Int. Cl. G06F 17/50; B21D 37/20

(52) U.S. Cl. CPC G06F 17/5018; B29C 33/3835; B21D 37/20

(57) ABSTRACT

A method for designing a first forming element for a forming tool that is intended for forming workpieces is provided. The forming tool includes the first forming element and at least one second forming element. The method includes the steps of: providing first data, characterizing an element geometry of the first forming element; providing second data, characterizing the second forming element; by way of an electronic computing device, carrying out a forming simulation on the basis of the first and second data, where a forming of a workpiece that is brought about by way of the forming elements is simulated by way of the forming simulation and a forming geometry of the workpiece; comparing the forming geometry with a predetermined target geometry; and if a difference determined by the comparison between the forming geometry and the target geometry exceeds a predetermined threshold, changing at least the first data.

### CROSS REFERENCE TO RELATED APPLICATION

This application claims priority under 35 U.S.C. § 119 from German Patent Application No. 10 2018 108 391.2, filed Apr. 10, 2018, the entire disclosure of which is herein expressly incorporated by reference.

### BACKGROUND AND SUMMARY OF THE INVENTION

The invention relates to a method for designing a forming element for a forming tool. The invention also relates to a forming element that is produced by way of such a method.

An appearance of a motor vehicle is decisively influenced by a geometry of components of the outer skin of the motor vehicle, which today are usually produced for example from fine aluminum or steel sheets with a thickness by way of a forming process. In particular, these outer skin components may have at least one curvature with a particularly small radius, known as a sheet-metal part edge. Such a bend in a visible region of the outer skin component is referred to as a sheet-metal part edge. The sheet-metal part edge typically runs or extends in a freeform surface area of the outer skin component. Furthermore, the sheet-metal part edge may on the one hand have a design function, for example form what is known as a character edge. Alternatively or additionally, the sheet-metal part edge may have a technical function, for example give the outer skin component a particularly high resistance to bending. In the construction of production motor vehicles, producing such sheet-metal part edges, in particular by way of forming, for example deep drawing, is found to be particularly demanding, since the curvatures for forming the sheet-metal part edge, in particular with especially small radii, are particularly difficult to produce by way of forming or deep drawing.

For process-related reasons, when forming or deep drawing sheet-metal components there is a reduction of the component thickness or sheet thickness in an area where a sheet-metal part edge is to be formed. Normally, in a curved area of the tool, a convex tool surface predetermines a geometry of the component on a concave side of the component. On a convex side of the component, opposite from the concave side of the component, the reduction of the sheet thickness in the area of the sheet-metal part edge has the effect that the radius of the sheet-metal part edge is different from, in particular greater than, a sum formed by the sheet thickness and the radius of the convex tool surface. Furthermore, it is particularly difficult, in particular impossible, to reproduce or control the radius of the sheet-metal part edge produced in a conventional way, so that two sheet-metal part edges of shapes that are respectively intended to merge with one another over two mutually adjacent components produced separately from one another may be offset in relation to one another and/or the respective radius of the mutually adjacent sheet-metal part edges disadvantageously deviate from one another.

Ways in which a particularly sharp sheet-metal part edge can be produced are already known from the prior art, in particular from the construction of production motor vehicles. Thus, for example, DE 10 2013 019 634 A1 discloses a method for producing a sheet-metal part by forming of a sheet-metal material, at least one sheet-metal part edge being created on a sheet-metal preform by local electromagnetic shaping of the sheet-metal material. However, such a way of doing this requires a particularly great amount of energy.

DE 10 2014 017 920 A1 discloses a method for producing a sheet-metal part having at least one sharp sheet-metal part edge by multistage forming of a sheet-metal material. This involves first forming the sheet-metal material in a first press-bound forming tool, the sheet-metal part edge to be produced being preformed with a larger edge radius and a camber. This is followed by further forming of the sheet-metal material in a second press-bound forming tool, the preformed camber being reduced and the sheet-metal part edge being fully formed. It takes a particularly long time in this case for the sharp sheet-metal part edge to be produced, because this method comprises two individual steps, to be performed one after the other. This means that this conventional method involves a particularly long time to carry out the process, which leads to a particularly cost-intensive production of the sheet-metal part edge.

Furthermore, DE 10 2014 221 878 A1 discloses a press tool, in particular a deep-drawing tool, for forming a sheet-metal material, an effective tool surface having a groove-like depression, whereby contact of the sheet-metal material with the effective tool surface is locally prevented.

However, in the case of both of the last-mentioned procedures, tool contact on both sides causes a cold forming, for example flow pressing, of the workpiece, one of the effects of which is a significant increase in a pressing force shortly before a lower dead center of the press-bound forming tool.

An object of the present invention is to provide a method and a forming element for a forming tool such that the disadvantages of the prior art can be avoided.

This and other objects are achieved by a method for designing a forming element for a forming tool in accordance with embodiments of the invention. This object is also achieved by a forming element in accordance with embodiments of the invention.

Advantageous refinements with expedient developments of the invention are specified in patent claims. Advantages and advantageous refinements of the method according to the invention for designing a forming element should be regarded as advantages and advantageous refinements of the forming element according to the invention for a forming tool, and vice versa.

According to the invention, a method for designing a first forming element for a forming tool that is intended for forming workpieces and includes the first forming element and at least one second forming element is provided. The workpieces may in each case be for example a metal part, in particular a sheet-metal part, which after processing or forming has taken place may form outer skin components of a motor vehicle. The first forming element and the second forming element may be moved relatively toward one another, the workpiece arranged between the two forming elements or held there being formed or deformed during the relative movement toward one another.

The method according to the invention includes the steps explained in more detail below. A first step comprises providing first data, which characterize an element geometry of the first forming element. For example, this may be a set of geometrical data of the first forming element that can be processed or further processed by way of electronic data processing. This set of geometrical data may be formed for example as a CAD data record (CAD: computer-aided design), an FE or FEM mesh (FEM: finite element method, a numerical method for considering the investigation of strength and/or deformation of solid bodies of a geometrically complex form).

A further, for example second step comprises providing second data, which characterize the second forming element. This may be a set of geometrical data of the second forming element.

Another, for example third step comprises carrying out a forming simulation by means of an electronic computing device on the basis of the first and second data, a forming of a workpiece that is brought about by way of the forming elements being simulated by way of the forming simulation and a forming geometry of the workpiece resulting from the forming thereby being calculated. This means that the electronic computing device, designed for example as a computer unit, simulates, for example by way of an FEM simulation on the basis of the respective set of geometrical data of the first forming element and the second forming element, how the workpiece is formed or deformed by the first forming element and the second forming element. In other words, a simulation result of the forming simulation provides the forming geometry of the workpiece or the geometry of the workpiece after a forming process. In particular, the forming geometry may take the form of a further set of geometrical data.

In particular, further data may be included in the forming simulation. These further data may comprise, inter alia, an original geometry of the component to be formed, a sheet or workpiece holder, data of a material of the workpiece to be formed, process parameters, such as process forces, process kinematics, etc., data of a punch insert and/or die insert, etc.

A further, in particular fourth step comprises comparing the forming geometry with a predeterminable target geometry. The target geometry may for example be predetermined or predeterminable by a preset geometry of the outer skin component of the motor vehicle that is to be produced. Furthermore, the target geometry may alternatively or additionally be predetermined or predeterminable by a target geometry or the set of geometrical data of one of the two forming elements, in particular a die of the forming tool. In addition, the target geometry may comprise an offset die geometry. A particularly easy, for example at least partially or completely automatic comparison of the forming geometry with the target geometry is made possible if the preset geometry is stored in a set of geometrical data. A further, for example fifth step comprises—in particular on the basis of a simulation—changing at least the first data if a difference determined by the comparison between the forming geometry and the target geometry exceeds a predetermined or predeterminable threshold. This means that in the fifth step it is checked whether a maximum permissible deviation between the forming geometry and the target geometry is exceeded. If this is not the case, the method is ended, the element geometry of the first forming element being definitively determined. If, by contrast, the maximum permissible deviation is exceeded, the first data, in particular the set of geometrical data of the first forming element, are changed and the first forming element is actually produced on the basis of that data. In the case of an actual production of the outer skin component by way of the first forming element thus produced, an actual geometry of the finished outer skin component is then more likely to correspond to the target or preset geometry. Correspondingly, a difference between the forming geometry determined by the first forming simulation and the actual geometry of the outer skin component can then be smaller than the difference between the forming geometry and the predeterminable target geometry.

It is contemplated for the forming element to be changed over a large surface area, that is to say locally unlimitedly. In order however to leave unchanged, inter alia, a line-of-light shape of the component that has the sheet-metal part edge, preferably only a local changing of the forming element is performed. In particular, only a local or locally limited adaptation of the set of geometrical data, in particular an edge radius, is performed, in that the first data are correspondingly changed. This results in a particularly advantageous gentle mechanical treatment of the forming tool, since only particularly little tool contact between the forming tool and the workpiece that is to be formed or has been formed at a lower dead center of the forming tool is ensured. Furthermore, a motor vehicle provided with the sheet-metal part edge then has a particularly advantageous impression on customers.

With the aid of this method, the first forming element is designed particularly advantageously, so that by way of this forming element an outer skin component of a particularly true form can be created. In particular in the construction of production motor vehicles, a first forming element produced in such a way allows a large number of outer skin components to be produced with a respective sheet-metal part edge in series production—in particular by machine—, the sheet-metal part edges having a particularly small edge radius in a controllable manner that can also be reproduced constantly and reliably.

It is also possible by way of the first forming element according to the invention to produce the outer skin component without surface area pressing or with only particularly little surface area pressing between the forming tool and the component. What is proposed in other words is a pressing process in which flowing or cold forging plays a particularly small part, ideally no part, whereby there is particularly little wear of the forming tool that is used for producing the outer skin component. As a consequence, the forming tool or the first and/or second forming elements is or are subjected to much lower process forces than in the case of a pressing process, in which flowing or cold forging plays a more important part.

A springback behavior, as occurs to a particularly great extent in the case of the pressing process, in which cold forging plays an important part, cannot be predicted by way of simulation methods that are usually used nowadays in the technical area of forming. This is so because these simulation methods are based on shell elements, in particular shell elements formed on the basis of the Reissner-Midlin theory. Since cold forging is advantageously eliminated almost completely in the case of the method according to the invention, or is at least particularly minor, it is not required to predict the springback behaviour to obtain reliability of the process. As a further consequence, no new simulation methods have to be developed, but instead simulation methods that are already widely used nowadays in development can also be retained in conjunction with the method according to the invention or the forming elements according to the invention.

In addition, in the case of the method, a thickness fluctuation of the sheet-metal part to be formed, for example as a result of tolerances etc., has only a particularly minor influence on the process forces occurring. This is so because, with an actual thickness deviating from a preset thickness of the component to be formed that is greater than the preset thickness, the process forces increase to a much lesser extent during the forming of the component in comparison with the pressing process dominated by cold forging. In other words, it is ensured in the method that the process forces do not exceed a required forming force, so that closing of the forming tool is not prevented by the process forces occurring.

Furthermore, particularly great robustness of the process with regard to the process forces during the forming can be ensured, because the first forming element is designed such that particularly little plastic deformation occurs along a direction of the thickness of the workpiece or of the workpieces due to upsetting.

In addition, it is possible in a particularly advantageous way to give an outer skin of the motor vehicle a character edge, which extends over at least two mutually adjacent outer skin components, for example over a fender and a vehicle door adjacent thereto. On account of the reliably reproducible edge radii of the respective sheet-metal part edges partially forming the character edge, the shape of the character edge over the mutually adjacent outer skin components is particularly constant, continuous and free from disturbing, discontinuous transitions.

It has proven to be particularly advantageous that, after the fifth step, the first four steps are carried out once again, the first data changed in the fifth step being used as the first data. This makes it possible in a particularly advantageous way to reduce the difference between the forming geometry and the target geometry still further. To put it another way, it is possible to make the predeterminable threshold particularly low, so that the first forming element can in reality create outer skin components of a particularly true form. As a consequence, an actual geometry of the finished outer skin component can correspond still more to the target or preset geometry. That is to say that a greater trueness of form or trueness of geometry of the outer skin components to be produced in series can be achieved.

In a further embodiment of the method, after carrying out the first four steps once again, the fifth step is carried out once again. This means that the first data already changed at least once before are accordingly changed once again. Alternatively, that is to say if a difference determined by the comparison between the forming geometry and the target geometry does not exceed the predeterminable threshold, the method is ended, the element geometry of the first forming element being definitively determined. Such a repetition of the steps until the predeterminable/predetermined threshold is at least reached or undershot allows production of the first forming element by way of which an outer skin component of a particularly true form, in particular an outer skin component with a sheet-metal part edge of a particularly true form, can be created. It should be understood here that this repetition may take place more than once, so that the method is entirely or partially carried out iteratively.

A difference between a surface of the forming geometry and a surface of the target geometry may be used as the threshold. In particular if the forming geometry and the target geometry respectively take the form of a set of geometrical data, this difference is particularly easy to determine.

It is particularly advantageous if the target geometry characterizes a visible side and/or a side of the workpiece different from the visible side, since sheet-metal part edges, in particular character edges, can in this way be formed in series with particularly true forms or true geometries and in a reproducible manner. In particular, the character edges have a particularly decisive influence on the appearance of the motor vehicle and considerably influence an impression of quality of the motor vehicle.

It is also of advantage if, when changing the first data, a surface is locally modified in an area of allowance, so that the target geometry is locally modified. In particular, this surface may be a surface of the first forming element. This means that a surface of the first forming element is modified in a locally limited area in such a way that an outer skin component produced by way of this forming element corresponds particularly exactly to the target geometry. For example, a local modification may be performed, in that in the area of allowance the surface is raised and/or lowered in comparison with a surface surrounding the area of allowance. In particular, such a modification can be reflected in the element geometry, for example in the set of geometrical data, of the first forming element. Preferably, the corresponding forming element remains unchanged outside the area of allowance, so that the only local, that is to say locationally limited, modification of the forming element requires particularly little effort.

The area of allowance can be locally modified particularly easily if a strip of allowance is added in the local modification. A strip of allowance should be understood as meaning a fraction of the first forming element that is added to the element geometry of the first forming element in the course of changing the first data. This fraction may be formed as an additional material and/or a removal of material. During actual production of the first forming element, its forming body may comprise a main forming body, which is defined by way of the first data being provided for the first time, and comprise the strip of allowance. Here, the main forming body and the strip of allowance may form the forming body, that is to say that the main forming body and the strip of allowance may be formed together in one piece. However, it is equally contemplated that the main forming body and the strip of allowance are produced separately from one another and are connected to one another in a frictionally engaging, interlocking and/or material-bonding manner.

It has also been found to be advantageous if a transitional area, in which the area of allowance and the remaining surface merge with one another, is formed continuously. In particular, this transitional area may be formed with a continuous curvature. It is equally contemplated that this transitional area is formed with a continuous tangent. In the case of such a continuous transition between the area of allowance and the remaining surface of the first forming element, it is ensured that the workpiece processed or formed by way of the first forming element is not subjected to any spatially particularly confined loading, for example with a notch effect, whereby the workpiece would be weakened and/or its surface damaged.

It is particularly preferred if a punch is used as the first forming element and a die is used as the second forming element. This means that the first forming element may be formed as a punch element and the second forming element as a die element. By way of the method for designing the first forming element, as a further consequence a forming tool, for example a deep-drawing machine, can then be provided, with a particularly advantageously formed punch, by way of which outer skin components with sheet-metal part edges or character edges lying in their free-form areas can be produced. Here, these sheet-metal part edges are then particularly sharp in the way desired, which is to say that these sheet-metal part edges can in each case have a particularly small radius, in particular on a visible side of the component.

The invention also relates to a forming element for a forming tool, the forming element being produced by way of the method described hereinabove. In particular in the construction of production motor vehicles, producing outer skin components by way of a deep-drawing machine is particularly advantageous, because particularly great and/or reliable reproducibility of the outer skin components to be produced or to be deep-drawn can be ensured.

A respective sheet-metal part edge or character edge, that is to say also the edge described herein, is actually defined or formed by a free-form surface or a number of free-form surfaces, while reference is made to radii with regard to a particularly simple description of the invention. In this connection, it should be understood that this invention is not restricted purely to radii, but in the same way can be applied to free-form surfaces, the respective free-form surfaces that define the edge being able to have at least one radius or a large number of radii. The respective surfaces of the forming elements and/or of the component may accordingly be surfaces that are curved once or twice.

Further features of the invention emerge from the claims, the figures and the description of the figures. The features and combinations of features mentioned above in the description and the features and combinations of features mentioned in the description of the figures below and/or shown in the figures alone can be used not only in the respectively stated combination but also in other combinations or alone.

The invention is now explained in more detail on the basis of a preferred exemplary embodiment and also with reference to the drawings.

### BRIEF DESCRIPTION OF THE DRAWINGS

FIG. 1 is a schematic sectional representation for a first forming element and a second forming element, and also a workpiece.

FIG. 2 is a flow diagram to illustrate a method for designing the first forming element.

FIG. 3 is a schematic sectional representation for the first forming element and the second forming element and also the workpiece, the forming geometry of which deviates from a target geometry.

FIG. 4 is a schematic sectional representation for the first forming element and the second forming element and also the workpiece, the forming geometry of which corresponds at least substantially to the target geometry.

FIG. 5 is a further flow diagram to illustrate the method for designing the first forming element in a further embodiment.

### DETAILED DESCRIPTION OF THE DRAWINGS

In the figures, elements that are the same or functionally the same are provided with the same designations.

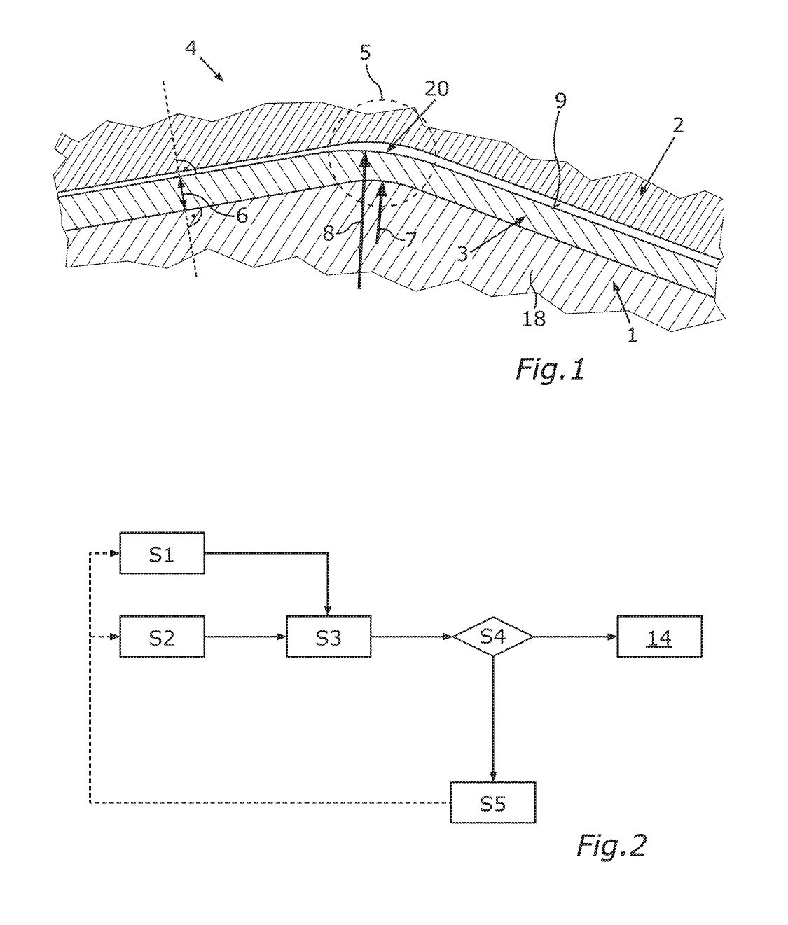

FIG. 1 shows in a schematic representation a first forming element 1 and a second forming element 2, and also a workpiece 3. The first forming element 1 and the second forming element 2 are movable in relation to one another, so that the workpiece 3 arranged between the two forming elements 1, 2 and held there is deformable during a relative movement of the two forming elements 1, 2. For example, the first forming element 1 may be a punch of a deep-drawing machine, while the second forming element 2 may be a die of the deep-drawing machine. This means that the first forming element 1 or the punch and the second forming element 2 or the die may be integral parts of a forming tool 4, in particular of the deep-drawing machine.

In a forming operation, in particular a deep-drawing operation, the workpiece or sheet 3 that is usually held between the two forming elements 1, 2 by way of a workpiece holder or sheet holder is given a shape or geometry that corresponds at least substantially to a geometry or part of the geometry of the second forming element 2. Here, the workpiece 3, which for example is metal and/or comprises plastic, primarily comes into direct contact with the first forming element 1. It is particularly preferred if there is only particularly little direct contact or in particular no direct contact at all between the workpiece 3 and the second forming element 2—or at least a concave part of the second forming element 2—during a forming operation. This is so because it ensures in a particularly advantageous way that a force with which the two forming elements 1, 2 are moved toward one another does not increase abruptly. This ensures that the forming tool 4 or the deep-drawing machine is subjected to particularly little wear, since mechanical loading of the machine can be kept particularly low in an advantageous way.

In vehicle construction, in particular in the construction of production motor vehicles, such a forming tool 4 may be used in order to produce particularly easily an outer skin of a motor vehicle comprising more than one outer skin component. There is often the need to give the individual outer skin components at least one bend with a particularly small radius or at least one edge in their free-form surfaces. On the one hand, such edges perform a design function, for example if the edges are respectively formed as a character edge. Such character edges have a decisive influence on an appearance or a design of a motor vehicle and it is desired that these character edges are formed particularly sharply. Apart from that, such edges in free-form surfaces of the outer skin components also perform at least one technical function, for example to direct precipitated water on the outer skin of the motor vehicle along a specific path, so that the precipitated water does not undesirably penetrate into an interior space of the motor vehicle. In addition, these edges give the respective outer skin component a greater resistance to bending, so that the outer skin can be formed particularly stiffly.

If the workpiece 3 is formed as intended by way of the forming elements, it is provided that a distance between the two forming elements 1, 2 in an end position of the forming tool 4 or of the two forming elements 1, 2 and an original component thickness correspond at least substantially. In FIG. 1, it can be seen outside an area 5 that a thickness reduction with respect to the original component thickness to a component thickness 6 has taken place during the forming or deep drawing of the workpiece 3 as a result of a shaping of the machine tool 4. Correspondingly, the depicted forming elements in FIG. 1 have assumed the end position during the forming of the component or workpiece 3. In the area 5, the decrease of the component thickness is particularly pronounced, since at this point the first forming element 1 or the punch has a radius 7, by way of which the workpiece 3 or the outer skin component is to be provided with an edge. A created radius 8, which extends along a visible component side 9, is much greater because of the component thickness than the radius 7, which is impressed in the workpiece 3 or the outer skin component by way of the first forming element 1. The created radius 8 is also greater here than a concave radius of the second forming element 2 or of the die, which is a result of the already described thinning of the material of the workpiece 3.

The radius 8 created during the deep drawing or by way of the deep drawing on the visible component side 9 can scarcely be set exactly. This has the consequence that the bend with the particularly small radius or an edge cannot be produced sufficiently accurately or sufficiently in accordance with a design specification in series production of the corresponding outer skin component.

In order therefore to be able to process the workpiece 3 by way of such forming in such a way that the finished outer skin component has a particularly sharp edge, for example a character edge, there is proposed a method for designing the first forming element 1, in particular for creating a geometry thereof, which is explained more specifically below.

FIG. 2 shows a flow diagram to illustrate the method. In a first step (or act) S1, an element geometry of the first forming element 1 is provided. Ideally, a first set of geometrical data of the first forming element 1 that can be processed or further processed by way of electronic data processing is available. This set of geometrical data may be formed for example as a CAD data record (CAD: computer-aided design), an FE or FEM mesh (FEM: finite element method, a numerical method for considering the investigation of strength and/or deformation of solid bodies of a geometrically complex form).

This means that step S1 comprises providing first data, which characterize the element geometry of the first forming element 1.

A second step (or act) S2 comprises providing second data, which characterize the second forming element 2. For example, an element geometry of the second forming element 2 may be provided as a further, second set of data formed as a set of geometrical data. In other words, the second step S2 may comprise providing second data, characterizing an element geometry of the second forming element 2. In particular, the first step S1 and the second step S2 may proceed simultaneously.

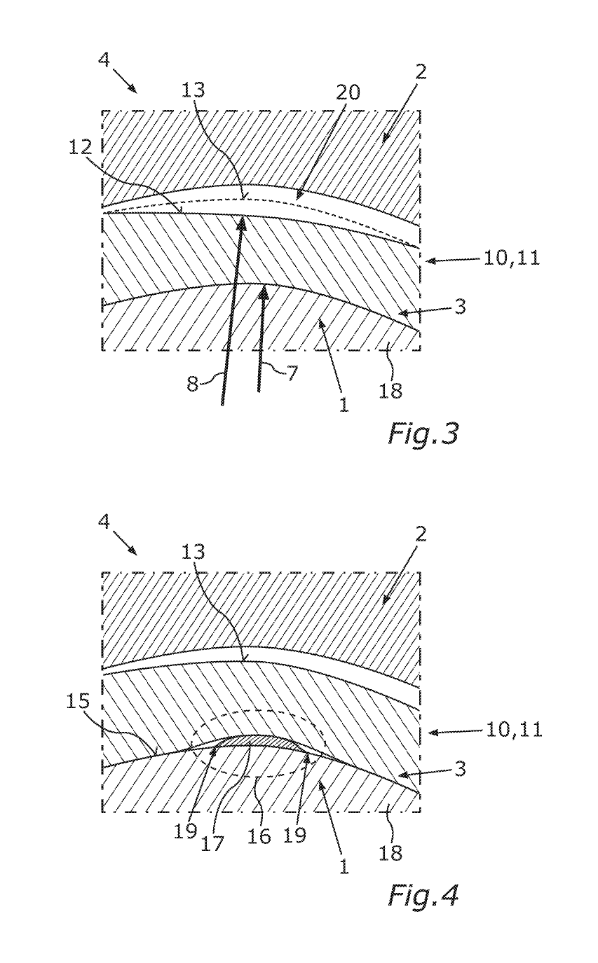

The first data and the second data are provided for an electronic computing device, for example are entered into this electronic computing device. The electronic computing device may be in particular an electronic data processing unit, for example a computer unit. Further data may be introduced into the forming simulation. These further data may include an original geometry of the component to be formed, a sheet or workpiece holder, data of a material of the workpiece to be formed, process parameters, such as process forces, process kinematics, etc., data of a punch insert and/or die insert, etc. By way of the electronic computing device, in a third step (or act) S3 a forming simulation is carried out on the basis of the first data and the second data. With the aid of the forming simulation, a forming of the workpiece 3 that is brought about during the forming operation by the forming elements 1, 2 is simulated, so that in this way a forming geometry 10 (see FIG. 3) of the workpiece 3 resulting from the forming process is calculated. Such a forming simulation may be performed for example using software, in particular FEM software that is run on the computer unit.

A fourth step (or act) S4 comprises comparing the forming geometry 10 that is created and provided in step S3 with a predeterminable target geometry 11 (see FIG. 3). The predeterminable target geometry 11 may be a further set of geometrical data, for example a die geometry, a die mesh, a component null geometry, etc., which contains information on the geometry of the outer skin component to be produced. In other words, the target geometry 11 is a preset geometry of the outer skin component that can only be accomplished in the case of the actually produced outer skin component under theoretical-ideal conditions. The target geometry 11 characterizes a visible side of the workpiece 3 or of the outer skin component. To put it another way, the visible component side 9 to be aimed for is modeled when creating or predetermining the target geometry 11, for example by way of CAD. This means that in step S4 a comparison result between the target geometry 11 and the forming geometry 10 created by way of the forming simulation of the outer skin component is produced and provided.

In a fifth step (or act) S5, the comparison result created in step S4 is evaluated. At least the first data are changed if the comparison result indicates that a difference between the forming geometry 10 and the target geometry 11 exceeds a predeterminable threshold. Such a case is illustrated by way of FIG. 3. Shown there in a schematic representation are the forming elements 1, 2 and also the workpiece 3, the forming geometry 10 of which deviates decisively from the target geometry 11. Accordingly represented in FIG. 3 is a formed workpiece 3, the forming geometry 10 of which is so different from the target geometry 11 that the predeterminable threshold is exceeded. Changing of the first data or of the first set of data of the first forming element 1 should be understood as meaning an adaptation of the element geometry of the first forming element 1 in order when actually producing the outer skin component or when actually forming the workpiece 3 to be able to form the radius 8 in such a way that it corresponds at least substantially to the target geometry 11. Accordingly, after step S5, that is to say after changing the first data, actual production 14 of the first forming element 1 may be continued on the basis of the changed first data.

If after carrying out step S4 it is alternatively found that the target geometry 11 and the forming geometry 10 closely coincide, in particular are congruent, the method for designing the first forming element 1 may be ended already after the comparison for the first time and the actual production 14 of the first forming element 1 may be continued on the basis of the unchanged first data directly after step S4.

The method described up to here, in particular for making the forming geometry 10 correspond as exactly as possible to the target geometry 11, is suitable for being carried out once again, in that at least steps S1 to S4 are carried out once again after the fifth step S5, the first data changed in step S5 being used as the first data. Such a rerun of steps S1 to S4 is particularly meaningful especially whenever the difference between the forming geometry 10 and the target geometry 11 previously determined by the comparison has exceeded the predeterminable threshold. In this way, a particularly small difference can be accomplished between the forming geometry 10 and the target geometry 11 in a renewed comparison in the repeated step S4, so that then the predeterminable threshold is not exceeded once again. This rerun is illustrated in FIG. 1 by dashed arrows, which extend from step S5 and lead to the first step S1 or to the second step S2.

This method may also be carried out iteratively, in that, after the repetition of steps S1 to S4, step S5 is carried out once again. Such an iteration of the method steps S1 to S5 allows the predeterminable threshold to be arranged particularly close to the target geometry. In other words, when the method is carried out iteratively, a particularly exact approximation of the forming geometry 10 to the target geometry 11 is achievable, so that the difference can be particularly small in the comparison in step S4. To put it another way, the method can be carried out iteratively until the predeterminable threshold is no longer exceeded, it being possible for this predeterminable threshold to be aligned particularly closely to the target geometry 11.

A difference between a surface 12 of the forming geometry 10 and a surface 13 of the target geometry 11 may be used for example as the threshold. In particular, the surface 12 may extend along the visible component side 9 or form it. And a visible component side 9 should be understood as meaning a side of the outer skin component that is facing away from the interior space of the motor vehicle and is facing a viewer located outside the motor vehicle.

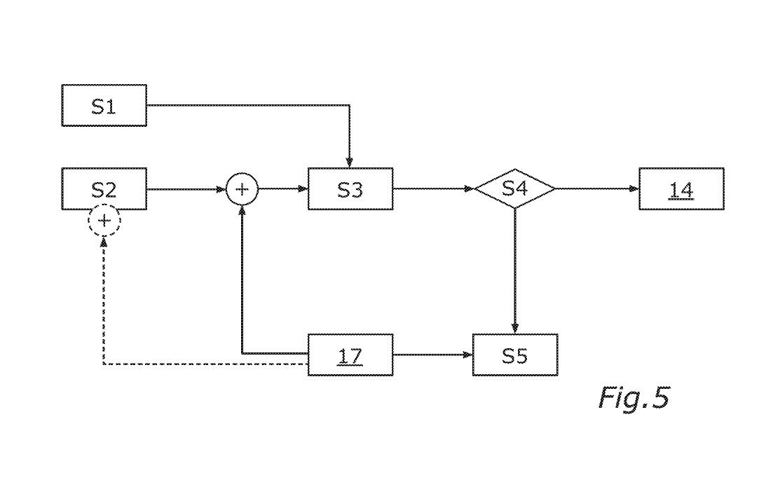

When changing the first data, a surface, in particular a forming surface 15, of the first forming element 1 is locally modified in an area of allowance 16 (see FIG. 4). For example, in order to modify the forming surface 15 locally, a strip of allowance 17 may be added to the element geometry of the first forming element 1, as indicated by means of the dashed arrow in FIG. 5, which shows a further flow diagram to illustrate the method for designing the first forming element in a further embodiment. In this case, a geometry of the strip of allowance 17 or of the local modification becomes an integral part of the element geometry of the first forming element 1. However, it is also contemplated that the element geometry of the first forming element 1 remains unchanged, so that the first data, the second data and geometrical data of the local modification or of the strip of allowance 17 are provided for the electronic computing unit.

In any event, the first data initially provided in step S1 are changed before they are then provided in step S3. This takes place for example in that data of the local modification, for example dimensions, positional information, etc., of the strip of allowance 17 are added to the data of the element geometry of the first forming element 1, so that the strip of allowance 17 is created in the area of allowance 16. As a consequence, the subsequent forming simulation is based on a virtual first forming element 1, which comprises the strip of allowance 17 or the local modification.

Shown in a schematic representation in FIG. 4 are the first forming element 1 and the second forming element 2 and also the workpiece 3, the forming geometry 10 of which corresponds at least substantially to the target geometry 11. This means that the local modification or the strip of allowance 17 has had the effect that the workpiece 3 has at least substantially assumed the target geometry 11, in particular in the area 5. In other words, the forming geometry 10 shown in FIG. 4 corresponds at least substantially to the target geometry 11.

The local modification or the strip of allowance 17 may together with a main forming body 18 form the first forming element 1. In particular, the local modification or the strip of allowance and the main forming body 18 may be formed together as one piece. However, it is also contemplated that the main forming body 18 and the strip of allowance 17 or the local modification are produced separately from one another, in order then to be connected to one another in a frictionally engaging, interlocking and/or material-bonding manner. This would allow for example the provision of a particularly flexibly usable first forming element 1, in the case of which different local modifications or strips of allowance 17 can be applied as and when required. To put it another way, in this case it is avoidable to produce the forming element 1 as a whole once again just when there is a changed strip of allowance 17. Instead, it is possible with particularly little effort to produce only the changed strip of allowance 17 or the changed local modification and to connect it correspondingly to the main forming body 18.

With a transitional area 19 formed continuously between the local modification or the strip of allowance 17 and the remaining forming surface 15 adjacent thereto and differing therefrom, it is ensured that the workpiece 3 processed or formed by way of the first forming element 1 is not subjected to any spatially particularly confined loading, for example with a notch effect. This is so because then the workpiece would be weakened in certain places and possibly suffer surface defects. The continuousness may take the form of the continuousness of a curvature or the continuousness of a tangent.

It should be understood that in FIG. 1, FIG. 3 and FIG. 4 a section through an edge or character edge 20 that extends at least substantially perpendicular to the plane of the drawing is depicted.

### LIST OF DESIGNATIONS

1 first forming element
2 second forming element
3 workpiece
4 forming tool
5 area
6 component thickness
7 radius
8 radius
9 visible component side
10 forming geometry
11 target geometry
12 surface
13 surface
14 production
15 forming surface
16 area of allowance
17 strip of allowance
18 main forming body
19 transitional area
20 character edge
S1 step
S2 step
S3 step
S4 step
S5 step

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A method for designing a first forming element for a forming tool that is intended for forming workpieces and includes the first forming element and at least one second forming element, the method comprising the acts of:
(A1) providing first data, which characterize an element geometry of the first forming element;
(A2) providing second data, which characterize the second forming element;
(A3) by way of an electronic computing device, carrying out a forming simulation on the basis of the first and second data, a forming of a workpiece that is brought about by way of the forming elements being simulated by way of the forming simulation and a forming geometry of the workpiece resulting from the forming simulation being calculated;
(A4) comparing the forming geometry with a predetermined target geometry; and
(A5) if a difference determined by the comparison between the forming geometry and the target geometry exceeds a predetermined threshold, changing at least the first data.

2. The method according to claim 1, wherein after act A5, acts A1 to A4 are carried out once again, the first data changed in act A5 being used as the first data.

3. The method according to claim 2, wherein after the repetition of acts A1 to A4, act A5 is carried out once again.

4. The method according to claim 1, wherein a difference between a surface of the forming geometry and a surface of the target geometry is used as the predetermined threshold.

5. The method according to claim 3, wherein a difference between a surface of the forming geometry and a surface of the target geometry is used as the predetermined threshold.

6. The method according to claim 1, wherein the target geometry characterizes a visible side and/or a side of the workpiece different from the visible side.

7. The method according to claim 5, wherein the target geometry characterizes a visible side and/or a side of the workpiece different from the visible side.

8. The method according to claim 1, wherein when changing the first data, a surface is locally modified in an area of allowance, so that the target geometry is locally modified.

9. The method according to claim 2, wherein when changing the first data, a surface is locally modified in an area of allowance, so that the target geometry is locally modified.

10. The method according to claim 8, wherein a strip of allowance is added in the local modification.

11. The method according to claim 9, wherein a strip of allowance is added in the local modification.

12. The method according to claim 8, wherein a transitional area, in which the area of allowance and the remaining surface merge with one another, is formed continuously.

13. The method according to claim 10, wherein a transitional area, in which the area of allowance and the remaining surface merge with one another, is formed continuously.

14. The method according to claim 1, wherein a punch is used as the first forming element and a die is used as the second forming element.

15. A forming element for a forming tool, the forming element being produced by way of a method according to claim 1.
